(19) United States
(12) Patent Application Publication
(10) Pub. No.: US 2017/0297939 A1
(43) Pub. Date: Oct. 19, 2017

(54) GREYWATER RECYCLING SYSTEMS AND DEVICES, AND RELATED METHODS

(71) Applicants: Jack Tseng, Burlingame, CA (US); Michael P. Green, Pleasant Hill, CA (US)

(72) Inventors: Jack Tseng, Burlingame, CA (US); Michael P. Green, Pleasant Hill, CA (US)

(21) Appl. No.: 15/099,948

(22) Filed: Apr. 15, 2016

(51) Int. Cl. C02F 9/00; B01D 61/12; B01D 61/14; B01D 61/22; B01D 61/42; C02F 1/469; C02F 1/44; C02F 1/42; C02F 1/32; B01D 61/02; C02F 1/00; B01J 39/18; B01J 39/04; B01J 20/20; B01J 20/10; B01D 61/58; C02F 1/04; C02F 103/00

(52) U.S. Cl. CPC C02F 9/00; C02F 1/04; B01D 61/12; B01D 61/145; B01D 61/22; B01D 61/42; C02F 1/4693; C02F 1/4691; C02F 1/444; C02F 1/441; C02F 1/42; C02F 1/32; B01D 61/025; C02F 1/008; B01J 39/18; B01J 39/04; B01J 20/20; B01J 20/103; B01D 61/58; B01D 61/422; C02F 2103/002; C02F 2209/03; C02F 2209/42; C02F 2303/02; C02F 2303/22

(57) ABSTRACT

A greywater recycling system for receiving, storing and recycling household waste influent, comprising: (a) a pre-filtration system comprising an open-ended transversal manifold placed in an elevated position, a series of micron-sized filters for collecting the influent, (b) a reservoir's storage system comprising: (i) a water level sensor for detecting the accumulated influent water level in a predetermined height, (ii) a pump, wherein the pump and the water level sensor are electrically connected together to automatically detect water level and activate or deactivate the pump, (c) the media housing filtration system comprising a series of filtration media for filtering out the effluent odor and contaminants, (d) an ultra-filtration system comprising the sub-micron sized filter, for sanitizing and purifying the outcome effluent, and (e) a check valve for adjusting effluent water pressure and directing the effluent flow direction.

### FIELD OF THE INVENTION

Described here are systems, devices, and methods for use in the field of waste water recycling. More specifically, described here are and systems and methods that may be used to a treatment, expandable collection, storage system used in the recycling of household and commercial building waste water.

### BACKGROUND OF THE INVENTION

According to recent reports in approximately 25 years, fresh water may become very scarce. After three years of research, the entire world's population may go thirsty by 2040 and remarkably by 2020, 40 percent of the world's population could be adversely affected by global water shortages.

Within an ever growing population is the ongoing demand for commercial goods in which requires water for manufacturing. This industrial practice particularly in time of drought and with the ongoing global pollution of lakes, rivers and oceans only continues to aggravate the potentials for looming shortages.

According to the Environmental Protection Agency, (EPA) the average American family uses approximately 320 gallons of water per day, of which about 30 percent is devoted to outdoor uses. More than half is used for watering lawns and gardens and where nationwide, landscape irrigation is estimated to account for nearly one-third of all residential water use, totaling nearly 9 billion gallons per day.

Therefore, being presented is a method and apparatus capable of implementation into any structure to perform water conservation through recycling. Most building structures typically provide a water entry source as well as a waste water exit. Water entry and exit is dependent upon a series of pipes commonly referred to as plumbing and where upon installation, is regulated under specific aspects of building codes. Building codes are referred to by building inspectors to insure a quality of construction and whereby, plumbing codes are written by the International Association of Plumbing and Mechanical Officials, (IAPMO).

Within plumbing codes IAPMO refers to three different types of water associated with construction; potable, grey and black water. During construction, potable water rates the highest in priority in regards to safe delivery and whereas household waste water commonly referred to as greywater, is generated daily by households while doing chores such as, washing dishes, clothes, brushing teeth, taking baths, showers, or any water utilized in which is not directly related to toilets or urinals. The third water classification is considered blackwater which is generated and directed into the sewer system after flushing toilets or urinals.

In most cases, both grey and black water exits the structure together and is directed flow into municipal sewer lines or where in rural areas, into septic tanks for treatment. Typically all waste water exiting methods are reliant upon gravity fall through piping in order to reach its final destination.

The present invention provides a method and apparatus whereas up to fifty percent of the greywater generated by a typically households can be recycled and reused for outdoor irrigation, or in some cases it can be diverted back into the structure to replenish toilet tanks after flushing. Over the years a wide variety of methods have been developed to perform greywater treatment and recycling, as an example, U.S. CA 2759407/Green, demonstrates a “Grey Water Recycle System” is comprised of a pump unit that installs to the bathtubs overflow valve that siphons and the waste water and redirects it to the toilets tank. Another unit in the system replaces the sink trap and also redirects waste water to the toilet tank. Another unit is at the point of the water shutoff for the toilet. This selector valve unit is the intake for the system that senses if the toilet tank is empty and thus accepts the greywater flow or rejects it (and/or communicates this information to the other units). This unit also allows for the user to fill the tank from the city water feed if no grey water is available. Another unit is at the counter sink u-joint which redirects sink greywater to the system intake selector valve. Standard and custom piping is used for existing bathrooms as well as custom built models.

Basically Green's invention relies on a siphon pump attached to the bathtub overflow to redirect bathtub greywater to the toilet tank.

U.S. Patent WO 2005056935 B1/Oekroes, demonstrates a method for greywater reusing system for the reuse of household greywater from washing to flush the toilet, consisting of a greywater tank built on top of a front loader washer equipped with a stronger primary water pump and a possibly a secondary water pump controlled by the electronic central unit in harmony with the water sensors. The characteristic feature of the invention is that the automatically operating mechanical flushing system can be used independently, or together with the electronic flushing system operated by the electronic control unit of the washer in harmony with the water sensors, valves and pump(s).

Oekroes invention relies on a system where greywater recycling involves a washing machine together with an incorporated greywater tank, for the economical flushing of toilets, consisting of a combined grey water tank is built together in one single body unit with a washing machine provided.

Another example of a greywater recycling system is CA 2771600 A1 titled “Electronic grey water recycling system”/Ryan, this device is an electronic grey water recycling system designed for residential application. The unit would typically be installed in a basement located near a washing machine and/or hot water tank. The City Water OUT line can be used to supply a hot water tank with relatively warmer water due to the heat recovered from the grey water captured in the tank from showers, washing machines, etc.

The system is designed to minimize regular maintenance—such as cleaning filters—by incorporating an automated back flush cycle, which is triggered when the water level reaches the high water level mark. Ryan relies on an ultrasonic method for cleaning during the back flush cycle.

In application WO 2014029989 A1, titled: “Waste Water Recycling” by Holdsworth, Murray and Pearson disclose the method for capturing, storing and supplying cleaned grey water to a first reservoir for greywater, a second reservoir for cleaned greywater and an outlet for supply of cleaned greywater. The system being configured such that the inlet feeds the first reservoir, the first reservoir feeds the second reservoir and the second reservoir feeds the outlet. Wherein the first and second reservoirs are fluidly connected via a valve configured to allow fluid flow from the first reservoir to the second reservoir but not from the second reservoir to the first reservoir. Such an arrangement allows a head of cleaned greywater to build up in the second reservoir, e.g. to service multiple flushes of a toilet connected to the outlet. Moreover, when there is a greater head in the second reservoir than in the first reservoir, any turbulent water in the first reservoir (typically caused by grey water entering that reservoir) will not be able to enter—and disturb—the water in the second reservoir, resulting in cleaner water from the outlet supplied from the second reservoir. To the extent that potable water is supplied to top up the second reservoir (e.g. in the event of insufficient greywater input), the valve prevents that potable water from flowing into the first reservoir, thereby reducing the amount of potable water required.

Most of the publications described above would likely not pass IAPMO, UL or the Nation Sanitation Foundation, (NSF) standards for approved materials, consumer safety, or receive certification for meeting and maintaining water assurance standards as set forth by plumbing code number IGC 324-2015, a reference for; “Alternate Water Source Systems”. IGC 324 code specifies specific requirements in regards to material types, physical characteristics, performance and electrical safety and in maintaining and delivering a specific water quality in which would meet EPA's standards for environmental release.

However, if any of the publications described above do meet the criteria of IGC 324, the water quality then would only be acceptable for subsurface drip irrigation and not for surface release or the replenishment of toilet tanks. See the reference at http://www.iapmo.org/Pages/GetCertified.aspx.

In California some cities due to drought initiatives have mandated the recycling of greywater in order to meet their water conservation efforts. Statewide water conservation was implemented by various State agencies in hopes of conserving approximately twenty five percent of the State's annual usage.

However, building codes in regards to greywater recycling technologies and installation were slow to evolve and are now just making their way into written codes. These codes provide building inspectors with installation mandates and whether a collection, treatment and storage system has achieved certification recognition “for public use”. Therefore, the object of the present invention is to provide a sanction approved water conservation apparatus based on written codes in which can be implemented by most households or commercial building operators, particularly since fifty two percent of the U. S. at the time of this writing is considered in drought.

All potable water which eventually becomes greywater may vary due to EPA's acceptable levels for turbidly, total dissolved solids, (TDS) biological oxygen demand, (BOD) chemical oxygen demand, (COD) and other organics commonly found or added to the water. Potable water will always vary in quality due to contaminate types, mineral content, geographic origin or by chemicals utilized during a treatment process to achieve a potable status. Therefore, various greywater treatment methods may be required or excised within a greywater recycling apparatus in order to meet prescribed water quality standards as set forth by various State and Federal agencies in regards to environmental release standards.

In response to some of the aforementioned methods and systems utilized in the treatment, storage and redistribution of greywater from residential or commercial structures will be addressed by the fields of this present invention.

### SUMMARY OF THE INVENTION

The present invention of the greywater recycling system can work as a secondary plumbing system commonly installed inside a structure of the building to identify and isolate greywater from the blackwater.

The present invention further provides an expandability feature in regards to reservoir storage. In large metropolitan areas property configurations, lot sizes or the property line distance between homes which sometimes can only be a few of feet often limits installation location or the catch basin's storage capacity.

Due to space limitations or property configurations the subterranean catch basin can be expanded in length or width increasing the present invention's storage capacity by the acceptance of a secondary reservoir where storage capacity is often dictated by landscape square footage or how often the landscaping requires irrigation.

Further, building codes often dictate installation setback from the structure's foundation or from adjacent property lines. These setback regulations relate to the distance away from the structure or from a property line where the greywater system can be installed. Building codes typically state in regards to bury objects such as a tank, for every inch of depth relates to the amount of setback inches required away from the structure's foundation. As for example, if an object having a twenty inch depth is buried, then it requires a twenty inch setback from the foundation. Therefore, the present invention's frontal area and depth tapers back away from the structure and back towards the reservoir allowing installation to be performed closer to the structure's foundation. The present invention designates this tapering section as a dry area which provides housing for electrical components as well as for the series of media housing filtration system 550.

The present invention further provides the option of working in conjunction with an optional ultrafine filtration or RIO system and whereas, these ultrafine systems should be considered as nano or ultra-micron membrane systems. These systems are used to produce an exceptional water quality, such as when using nano membranes during reverse osmosis, (RIO) for potable water applications.

Unfortunately, most homes and commercial building are already equipped with surface irrigation, (sprinkler) systems in which due to EPA's water quality requirements for spray, (surface) irrigation, the catch basin's filtration systems does not meet the EPA's standards for spray irrigation. Therefore, the catch basin would have to work in conjunction with an ultra-fine filtration system in order to produce and maintain the standards for surface release.

Under IGC 324 there is an allowance for surface spray but only if the catch basin works in conjunction with an ultrafine filtration system accompanied by flow through a ultra-violet light, (UV). Further if the catch basin system works in conjunction with the ultrafine filtration and UV system then the treated greywater can be returned back inside the structure and used to replenish toilet tanks.

However, in some irrigation applications and due to daily household greywater generation, a complete catch basin, ultrafine filtration and UV system may not satisfy a full spray irrigation cycle. This presents irrigation inadequate's for the home owner as well as to commercial building operators.

According to most Public Health Departments, the commingling of treated greywater with potable or municipal water is not allowed. To overcome the irrigation cycle problem, make up water from an additional source such as municipal may be used but only when taking the proper precautions to prevent cross contamination due to water commingling contact.

An approved method in preventing cross contamination is a method commonly known by the plumbing industry as an “air gap”. An air gap is simply an atmospheric opening existing between the two types of waters. An air gap according to the plumbing industry is an unobstructed vertical space between a water inlet and the flood level of a fixture.

In the case of the present invention, an air gap method can be implemented and maintained inside the storage reservoir between a municipal water inlet and the prescribed grey water full point. The air gap method allows maintaining enough water inside the reservoir at all times to complete the irrigation task.

To prevent over flowing the reservoir with municipal water an electric shut off valve connected to the municipal water inlet can be utilized with the electric valve closing or opening triggered by the water level sensor. Optimally, if the level sensor were to reach its predetermined low setting it would open the valve allowing an inflow of municipal water and whereas, once reaching a predetermined high level and before closing up the air gap, the level sensor would trigger the valve to close.

In response to some of the aforementioned methods and systems used in the treatment and transfer of grey water for recycling will be addressed by the fields of the present invention. These, other features and advantages may be incorporated into certain embodiments of the invention which will become more fully apparent from the following description and appended claims. However, due to redundancy of multiples of sinks, toilets, bathtubs and showers, the present invention explanation should be interpreted as “a series of” unless otherwise noted. Therefore and once explained, the present invention should not require that all the advantageous and features be described herein or be incorporated into every embodiment of the invention.

### BRIEF DESCRIPTION OF THE FIGURES

The present invention will become more fully understood from the detailed description of the accompanying drawings:

FIG. 1 illustrates a schematic of conventional household greywater sources, their relationship with purple piping and blackwater flow from a toilet or urinal.

FIG. 2 illustrates a schematic of the current greywater recycling system and how the system works in conjunction with the pre-filtration system, the reservoir's storage system, the media housing filtration system, and the ultra-filtration system.

FIG. 3 illustrates the inside view of the pre-filtration system with the structure of the manifold.

FIG. 4 illustrates the side view of the structure of the catch basin reservoir enclosing the pre-filtration system, and the attached tapered bay housing for extra space storage.

FIG. 5 is a plain view of the greywater recycling system illustrating the influent and effluent flow paths and individual component placement.

### DETAILED DESCRIPTION

Described here are systems, methods, greywater recycling devices, and positioning components that can be used in the greywater recycling. Further, methods for making greywater recycling are described.

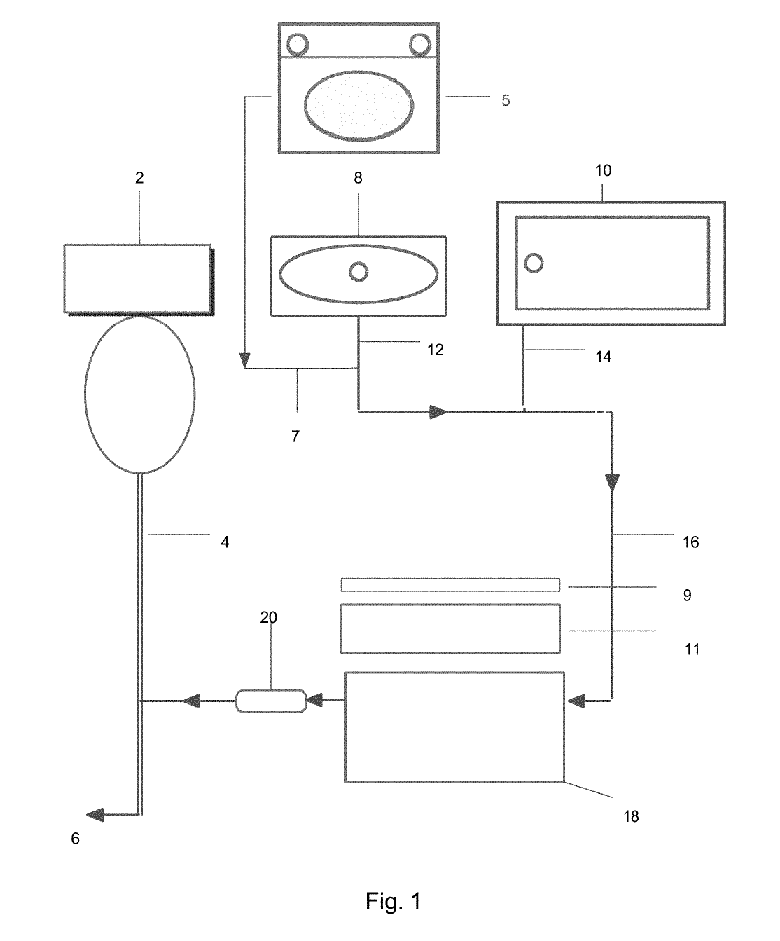

FIG. 1 illustrates a flow diagram of a conventional home or commercial building where greywater can be accepted and treated for recycling. Within building codes are for three different of water classifications associated with structural plumbing; potable, grey and blackwater. Within these codes are regulations governing greywater recycling systems and where only selected greywater sources can be utilized for collection and recycling. In other words, within homes and commercial buildings are greywater sources that according to plumbing codes are not suitable for collection. These sources include greywater coming from kitchen sinks, garage disposes and dishwashers. This is mainly due to food contamination contributing to bacteria, virus accumulation and growth. Greywater contributed by these sources are directed flow into the sewer system along with blackwater obtained from toilet or urinal flushing.

FIG. 1 illustrates a conventional recycling system 100. The individual bathroom section having blackwater generated by a toilet 2 in which when flushed is directed flow into a dedicated sewer line 4. The blackwater once exiting sewer line 4 flows into a master sewer pipe 6 having connection to the main sewer system. The greywater coming from either of the washing machine 5, the Bathroom sink 8, bathtub or shower 10 can be plumbed with secondary piping more commonly referred to as purple piping, 12 and 14 which collects and directs greywater flow towards purple master collection pipe 16.

Master collection pipe 16 receives greywater from the various approved sources and directs flow under gravity influence into a subterranean catch basin 18. The subterranean catch basin 18 of the conventional system 100 is usually buried below ground level to accept a gravity fall rate in the deliverance of greywater from the structure as opposed to utilizing an electric pump for delivery.

During installation the hole dug for the subterranean catch basin system 18 is organized such that the removal lids sit flush with ground level. However, in situations where a concrete slab floor may be planned for new construction or where the greywater system is planned as a retro-fit system to an older structure utilizing a slab floor, it may require the catch basin 18 to be buried deeper in the ground in order to receive an ampule gravity flow. Slab floors in general often hinder and prevent an ample flow due to existing sewer pipe poured in concrete during construction sit within or just below the slab. In these cases, the catch basin 18 of the conventional system may require a deeper burial rate in order to achieve ampule gravity flow. If the catch basin 18 requires a lower burial rate an extension ring 11 having the same outside dimensions as the catch basin housing 18 and lid 9 can be installed around the outer perimeters where the lid 9 normally would install. Once the ring 11 is installed it makes provisions to accept and mount the lid 9. The extension ring 11 is used to elevate the lid to the surrounding ground level and provides a series of vertical through holes used to retain bolts required for lid 9 and extension ring 11 installation to the catch basin 18.

Under current building codes the lid 9 of the catch basin system 18 must be colored in purple for greywater identification and further, it is permanently marked listing a series of safety precautions. These precautions include having the manufacture name, the maximum influent capacity, “Gray Water”, “Danger” and “Unsafe Water” and in addition, the lid 9 must be capable of sustaining a weight bearing load of approximately three hundred pounds or better.

As shown in FIG. 1, the conventional recycling system 100 has disadvantages for greywater recycling because the catch basin 18 can be overwhelmed too fast or with too much influent flow when the influent is provided out flow passage from the catch basin 18 through an attached back flow preventer valve, 20. Backflow is a term used in plumbing for the unwanted flow of water in a reverse direction. Sewer contamination can be of a serious health risk if allowing sewer constituents entry into a water supply. For this reason, building codes mandate a series of measures and backflow prevention devices to prevent sewage backflow and therefore, the back flow preventer valve 20 location must allow a connection between the catch basin 18 and sewer line 6 in order to prevent a back flow of sewage from entering into the catch basin housing 18. However, the conventional recycling system 100 usually cannot solve the backflow problems described above.

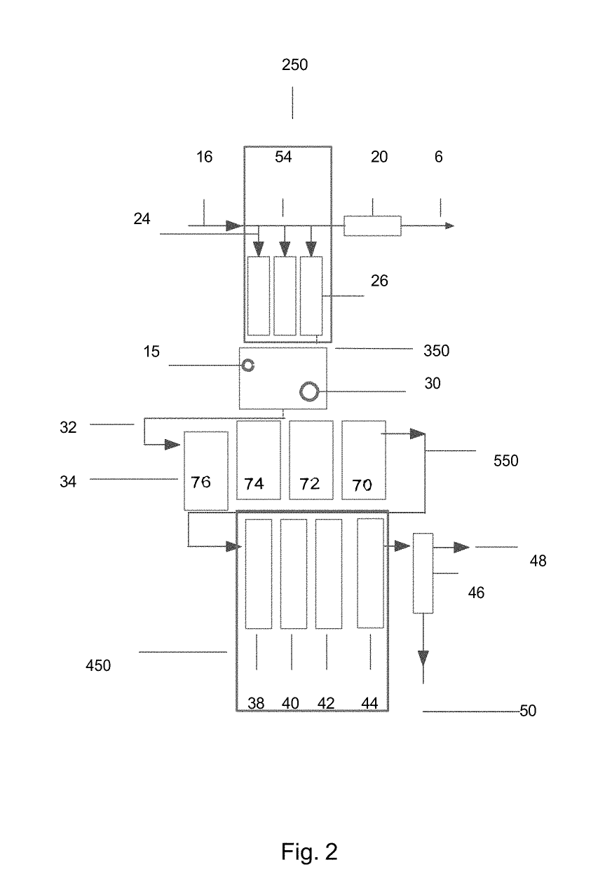

FIG. 2 illustrates the current invention of the graywater recycling system 200, with a schematic flow diagram pertaining to influent treatment, storage and distribution. The greywater recycling system 200 is comprised of a pre-filtration system 250, a reservoir's storage system 350, a media housing filtration system 550, and an ultra-filtration system 450.

The influent 16 first enters into the pre-filtration system 250 which is composed of an open-ended manifold 54 incorporating a series of descending exit openings 24. These descending exit openings 24 also contain a series of attached pre-filters 26. The pre-filters 26 can be micron-sized, between fifty to hundred microns. These pre-filters 26 can be applied to withhold and remove household solids such as hair, food particles or washing machine lint before the greywater enters into the reservoir's storage system 350. The pre-filters 26 can be removed and reversed flushable to allow the consumer to remove the pre-filters 26 periodically for inspection, cleaning or replacement. The number of the descending exit openings 24 can be single or plural and expandable based on the needs of the users.

In FIG. 2, once the inflow of greywater influent 16 has completed the pre-filtration system 250, but while still under gravity influence, the influent 16 is then allowed migration into the reservoir's storage system 350. On the side wall of the reservoir system 350, a water level sensor 15 is incorporated and utilized to prevent the reservoir's storage system 350 from overflowing. Once the water reaches a predetermined height, the sensor 15 electrically activates a submerged transfer pump 30 mounted down inside the reservoir system 350. The pump 30 is utilized to transfer the pre-filtered influent 32 into a series of individual housings of the housing system 550 containing known filtration media 330 such as, activated carbon, green sand, clays, deamacious earth, kinetic degradation flux or into a ion resin bed housing, all known to reduce or remove certain contaminate types or water hardness commonly associated with greywater. The influent transfer pump 30 produces enough pressure to push the influent 16 to and through the media 330.

The life span or loading of the media 330 is determined by the milligrams of contaminate contained within a liter, (mg/l). Once the greywater has passed through the pre-filter stage only microscopic contaminate such as; organics, chlorine, heavy metals, phosphorus, total coliforms remain. These types of contaminate are easily absorbed by the different individual types of media 330.

Since each of the different media types individually target certain types of contaminates, a suggested flow progression through the different housing system 550 should be practiced in order to reduce media loading and to preserve the media's longevity. As an example, detergents coming from the various greywater feed sources should be filtered out first to prevent media 330 surfactant loading and to improve the water's turbidity.

During the flow progression the influent 16 should be first subjected to a starting media 76 in similar to cretaceous sandstone having a sieve size in the range of two hundred. As the influent 16 flows through the cretaceous sandstone and due to sieve size, detergent surfactants are adsorbed by sticking to individual sand gains thus removing them out of solution and helping to clarify the water. Further, any particulate solids which may have escaped the pre-filtration stage will be trapped by the sandstone preventing solids from transferring into the next media housing.

The next media inline 74 should be in similar to manganese greensand having the same sieve size as the cretaceous sandstone. Manganese greensand is capable of reducing iron, manganese and hydrogen sulfide through oxidation and filtration and helps to reduce water odor perhaps from stagnate water stored within plumbing pipes or from a washing machine. Further like the cretaceous sandstone, the sieve size helps to improve turbidity by further trapping detergent surfactants and solids which may have escaped the cretaceous sandstone housing.

The third inline media 72 should be in similar to activated carbon having a sieve size around ten. Activated carbon is commonly used in water treatment due to its ability to collect and confine certain types of contamination within its microscopic pores. Activated carbon is known to reduce or remove a wide range of environmental water contaminants including; non-biodegradable organic compounds (COD), absorbable organic halogens (AOX), toxicity, color compounds and dyestuffs, inhibitory compounds, aromatic compound including phenol and bis-phenol A (BPA), chlorinated and halogenated organic compounds and pesticides.

A next inline media 70 should be in similar to kinetic degradation fluxion, (KDF). KDF is known to reduce or remove free chlorine, (up to ninety five percent) contained within the influent water. KDF media is composed of high-purity copper-zinc granules and when wetted performs a function of redox, (exchanging of electrons) to remove chlorine, hydrogen sulfide, water soluble heavy metals and microorganisms within the influent.

According to EPA's water quality values, (EPA/625/R-04/108 a guideline for water reuse, the following list of contaminate and its acceptable levels for environmental release present the following filtration challenges to the greywater recycling system:

| Influent | Treated Water Quality Required | |
|---|---|---|
| Parameters: | for Environmental Discharge: | |
| TSS | 5 | mg/l |
| Turbidity | 2 | NTU |
| BOD | 10 | mg/l |
| COD | 20 | mg/l |
| TOC | 1 | mg/l |
| Total Coliforms | 1 | cfu/100 ml |
| Fecal Coliforms | Non-Detectable | |
| Helminth Eggs | 0.1/l | |
| Viruses | 1/50 l | |
| Heavy Metals | .01/l | |
| Inorganics | 450 | mg/l |
| Chlorine Residual | .5 | mg/l |
| Nitrogen | 1 | mg/l |
| Phosphorus | 1 | mg/l |

To one skilled in the art, any number of media housing or media types could be utilized during the filtration process to achieve a reduction or removal of EPA's listed contaminates or to achieve a desired degree of contaminate removal for environmental release and where flow progression, media types or the number of housing utilized during the treatment process should not be limited.

In one embodiment, the present invention of the greywater recycling system 200 provides outlet options to works in conjunction with an ultra filtration system 450. To meet the water quality standards as set forth by EPA for environmental release, the ultrafine filtration systems 450 contains the filters in the sub-micron range to produce a better quality of effluent coming out of the catch basin.

Still in another embodiment, the ultra filtration system 450 contains the ultra micron filters 38 can be specified with special chemical coating known as being detrimental to bacteria and viruses. Water being very vulnerable allows housing of aquatic pathogens capable of causing disease and is easily adsorbed or leached through soils to contaminate groundwater aquafers or wells.

Still in another embodiment, the ultra filtration system 450 contains a housing 40 which can be incorporated into the greywater recycling system 200. The housing 40 contains ionic resin beads which are known to reduce or remove water hardness minerals or to treat certain types of aquatic pathogens within the influent stream. If the original tap water was delivered to the structure containing high levels of minerals then concurrently the waste greywater will be the same.

Still in another embodiment of the current invention, the ultra filtration system 450 contains a reverse osmosis system, the (R/O) system 42. The ultra micron filter 38 and the Housing 40 are often used to reduce or remove mineral content particularly prior to influent entry into the RIO system 42. Such R/O system 42 is commonly used to produce potable water sometimes from a blackish or ocean water source or to provide a higher grade of water treatment. Prior for the influent to entering the RIO system 42, the ultra micron filter 38 and the Housing 40 with resin beads are commonly used to help prevent filtration membrane loading due microscopic contaminate or high mineral content which traps within membrane pores causing them to plug or fowl creating a loss in efficiency.

Still in another embodiment, the ultra filtration system 450 contains the capacitive deionization (CDI), the elector-dialysis (ED), or the distillation system which provide similar filtration functions as RIO system 42.

Still in another embodiment of the current invention, the ultra filtration system 450 contains a ultra-violet (UV) light system 44. Once processing through the R/O membrane 42, the influent is then subject to a UV system 44 which is known to be effective in disabling harmful viruses and preventing their reproduction. The UV is used in many applications including being used to disinfect both well and municipal water supplies. The UV system 44 is used as a second defense to insure micro-organisms are not introduced into the environment.

Once traversing through UV system 44 the effluent is received by a check valve 46 which can be adjusted by the liquid pressure. The check valve 46 can be applied to control the effluent flow direction. In one embodiment to apply treated greywater for subsurface irrigation purposes, the effluent can be directed by the check valve 46 with the spring resistance to flow and exit directly to line 48 when there is no optional filtering devises such as the ultra micron filters 38, the RIO system 42, and the UV purification system 44 available. In another embodiment, when the above filtering devises are available (i.e., with the ultra micron filters 38, the R/O system 42, and the UV system 44), but due to a lack of spring resistance of the check valve 46, the effluent flow is directed to the outlet line 50 which directs the flow to the optional ultra-filtration system 450.

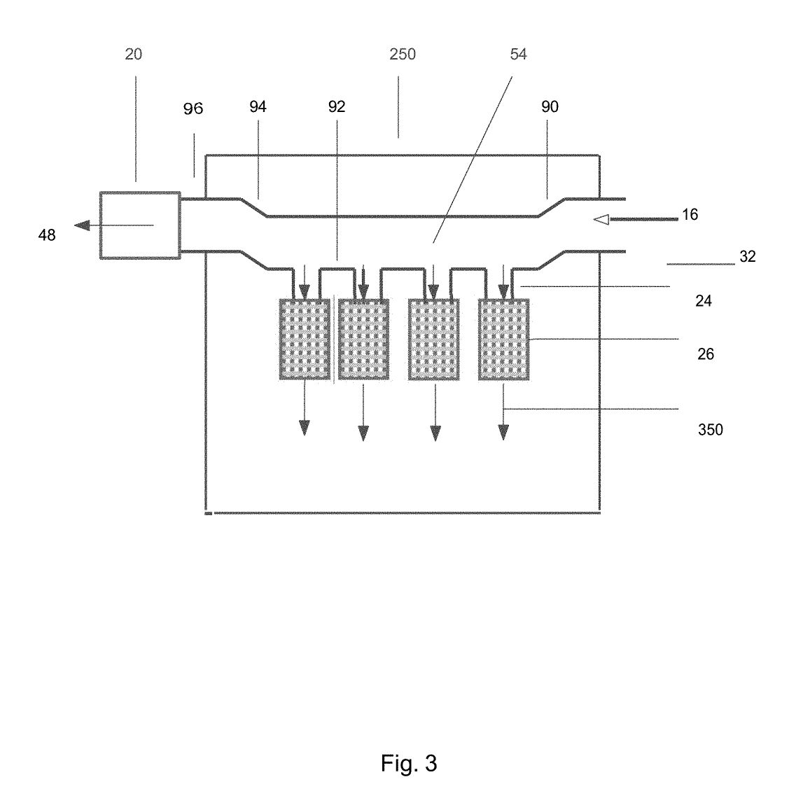

FIG. 3 illustrates how the pre-filtration system 250 work in the greywater recycling and filtration. In FIG. 3, the pre-filtration system 250 receives influent flow through the manifold 54. The manifold 54 mounts in an elevated position in relationship to the pre-filtration system 250 and mounts horizontally across the system housing 250. The manifold 54 utilizes a series of rubber gaskets in which form a seal against the side wall of the ultra-filtration system 450 and prevents the influent leakage from the manifold 54.

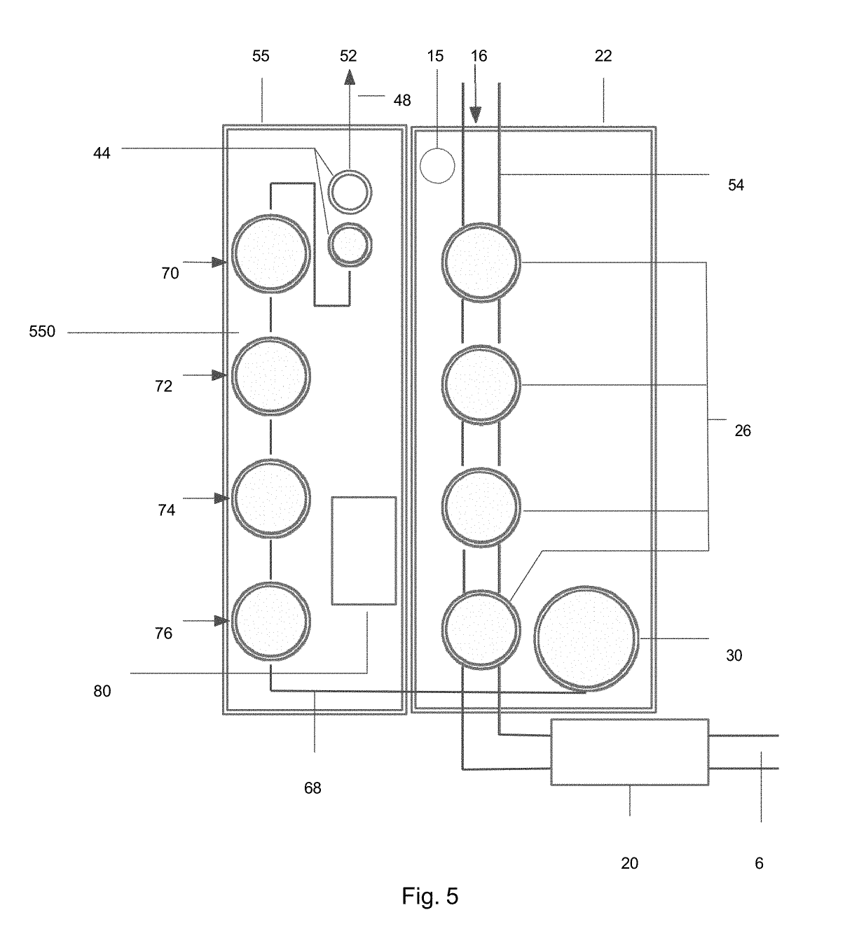

As shown in FIG. 5, the manifold 54 comprises several portions. The incoming influent 16 flows into the first horizontal plane portal 32. Next to the first horizontal plane portal 32 is a descending curvature 90 connected to the first horizontal plane portal 32 and is lowered in a relative height for allowing the influent to migrate under gravity. The descending curvature 90 is lowered comparing to the horizontal level of the first horizontal plane portal 32. The lowered portion of the descending curvature 90 can allow the influent 16 to flow under gravity easily to the next portion of the manifold 54. Next, the influent 16 flows into the second horizontal plane portal 92 connected to descending curvature 90. The second horizontal plane portal 92 contains multiple descending exits 24 coupled with multiple micro-sized filters 26. The exists 24 allow the influent to migrate downward through a series of micro-sized filters 26 and enter into the reservoir's storage system.

The manifold 54 further contains an ascending curvature 94 connected to the second horizontal plane portal 92. The ascending curvature is designed to be raised in a relative height comparing to the second horizontal plane portal 92, for redirecting the overflowed influent back to the second horizontal plane 92. In the case when the influent 16 flushes through the manifold 54 too fast to the third horizontal plane portal 96 and pass the exits 24 without going downward to the filters 26, the overflowed influent 16 accumulating into the portion of the ascending curvature 94 can be redirected back into the lowered second horizontal plane portal 92 and then migrate into the filters 26. The last portion of the manifold 54 contains a third horizontal plane portal 96 connected to the ascending curvature 94 for allowing the influent to exit, and a one-way backflow valve 48 attached to the third horizontal plane 96 for allowing the influent flow out to the sewer system in a one-way direction. The one-way flow valve 20 is connected to the sewer system. The one-way flow valve 20 is more commonly referred to as a “back flow preventer valve” which prevents sewage back up from entering into the catch basin system. In another embodiment, the one-way backflow valve 48 is pressure-operated to allow the influent coming from the manifold 54 to enter into the sewer line but not backflow into the manifold 54.

In another embodiment, there are multiple ascending curvatures 94 coupled with multiple corresponding third horizontal plane portals 94. Still in another embodiment, there are multiple third horizontal plane portals in connection with multiple descending curvatures 90. The design of multiple horizontal plane portals, together with multiple descending and ascending curvatures facilitate the influent 16 to be recycled and filtered in multiple stages with the micro-sized filters 24, and to prevent overflowed influent 16 from directly flow through the sewer system.

FIG. 3 illustrates the detailed structure and components of the pre-filtration system 250. The pre-filters housing 26 of manifold's 54 features the micron rating that allow the influent 16 to migrate downwardly due to the pull of the gravity. The gravity migration of the influent 16 can work in a manner to withhold household solids such as hair, food particles or washing machine lint prior to the entry of the influent 16 into the catch basin's reservoir 22 (FIG. 5). The pre-filters 26 are removable and further are reversely flushable, allowing the consumer to remove the pre-filters 26 periodically for inspection, cleaning or replacement.

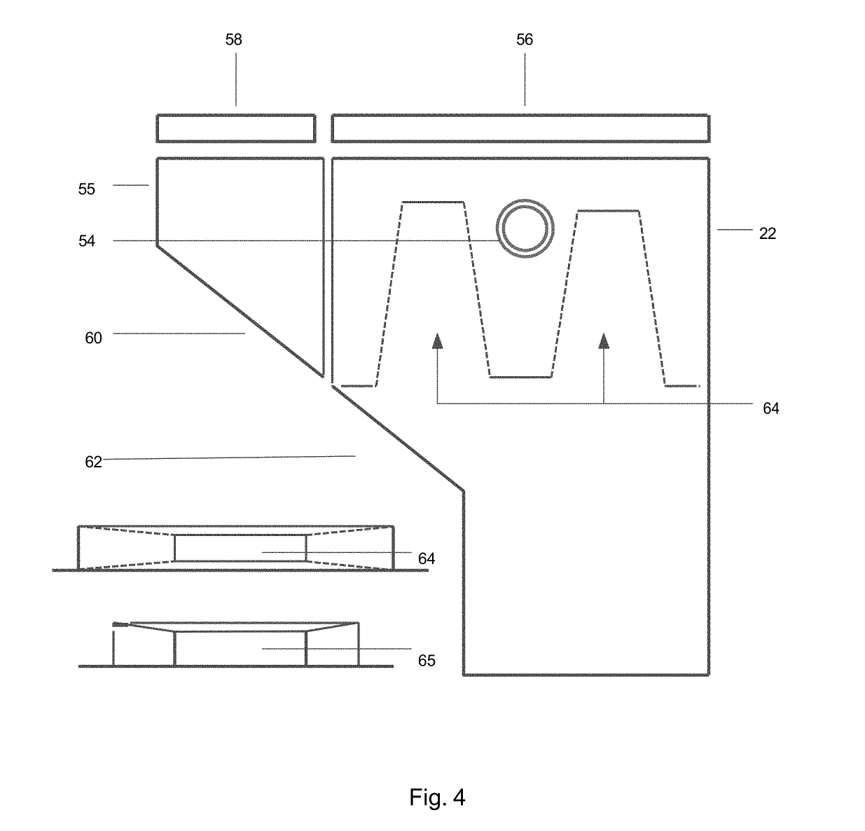

FIG. 4 illustrates the structure of the catch basin reservoir 22 enclosing the pre-filtration system 250, and the attached tapered bay housing 55 for extra space storage. In reference to FIG. 4 a tapered bay housing 55 is used to house various electrical components of the greywater recycling system 200. Both the housing 55 and the reservoir section 22 are accessed for internal maintenance by removing their enclosing lids 58 and 56. The tapered bay section 55 is designated as the dry area of the system 200 and therefore is used to house electrical components such as an enclosed electrical box which distributes power to the UV system 350 and to the submergible the transfer pump 30 located inside the reservoir's storage system 350. The tapered bay housing 55 also provides a housing area for the series of media filters 330 which require accessibility for maintenance.

The tapered bay housing 55 is dedicated primarily to influent storage but also provides housing for the submergible transfer pump 30, influent level sensor 15 and the receiving manifold 54.

The frontal 60 and the depth area of the tapered bay 55 and the reservoir taper 62, is designed to tapper away from the structure allowing the system 200 of the current invention installation to be performed closer to a structure's foundation.

In FIG. 4, the catch basin reservoir 22 allows the influent capacity expansion by receiving one or more additional reservoirs. Secondary reservoirs can be attached to the primary reservoir by using a plurality of tapering receiving slots 64 working in conjunction with corresponding plurality of tapering protruding blocks 65 and wherein, the first housing defines two or more protruding block 65 and thereon, the second housing defines two or more corresponding receiving slots 64 which allows mating migration and final attachment to occur between one or more secondary sections to a first section.

The series of receiving slots 64 and corresponding protruding blocks are incorporated on each side wall of the reservoirs and therefore, the plurality of tapering receiving slots 64 are primarily located on the frontal side of the reservoir 22 correspond with a plurality of tapering protruding blocks 65 on the backside of the tapered bay section 55 allowing a slide together fit for attachment made between the two housings 64 and 65.

FIG. 5 illustrates a schematic view of how the components are installed inside the catch basin's reservoir 22 and inside the tapered bay section 55. The reservoir section 22 provides housing for the open ended manifold 54 and for the series of pre-filters 26. In FIG. 2, the influent flow 16 is received by the manifold 54 which directs the influent 16 towards the series of pre-filters 26. Under gravity influence, the influent 16 traverses through the series of per-filters 26 and into the reservoir 22 where it's allowed accumulate. In cases where the manifold 54 may be overflowed with influent 16, the opposite end of the manifold 54 is left open to provide entry into a one way back flow preventer valve 20 which connects directly to the sewer system 6 in FIG. 2.

Within the reservoir 22, a submergible pump 30 is housed which is electrically activated by the water level sensor 15 once the influent 16 accumulation level reaches a predetermine height. In FIG. 5, the submergible pump 30 and the water level sensor 15 are electrically wired together to a relay located inside the electrical box 80. The relay is used to open or close an electrical circuit between the pump 30 and the water level sensor 15. Once the influent 16 reaches a predetermined height, the electrical circuit closes via the relay and completes an electrical circuit between the sensor 15 and the pump 30. Once the influent 16 inside the reservoir 22 has depleted, the sensor 15 then detects the low level water, and opens up the relay that breaks the electrical circuit can then cause the pump 30 to shut down.

Once the pump 30 is activated, it pumps the influent 16 through the piping 68 which connects to media housing system 550 which contains cretaceous sandstone. The cretaceous sandstone 76 is used mainly to remove detergent surfactant and suspended solids which may have escaped the pre-filtration process.

Once traversing through the cretaceous sandstone housing 76, a pressure is created when the influent 16 under the pump 30 will be pushed into the media housing system 550 containing the manganese sandstone 74. The manganese sandstone 74 is somewhat in redundant to the sandstone but does remove iron, hydrogen sulfide, reduces any stagnated water odor and helps to further improve the influent turbidity.

In another embodiment, when traversing through the manganese sandstone housing 74, the influent 16 is under the pump pressure that will be pushed into media housing system 550 which contains the activated carbon 72. The activated carbon 72 is commonly used in the water treatment due to its ability to collect and confine certain types of contamination within its microscopic pores. The activated carbon 72 is applied to reduce or remove a wide range of the environmental water contaminants including; non-biodegradable organic compounds, absorbable organic halogens, toxicity, color compounds and dyestuffs, inhibitory compounds, aromatic compound, chlorinated and halogenated organic compounds and pesticides.

Still in another embodiment, the influent traversing through the activated carbon housing 74 under the pump pressure will be pushed into the media housing system 550 which contains kinetic degradation fluxion, (KDF) 70. KDF is known to reduce or remove free chlorine, (up to ninety five percent) contained within the influent water. KDF media is composed of high-purity copper-zinc granules and when wetted performs a redox function, (exchanging of electrons) to remove chlorine, hydrogen sulfide, water soluble heavy metals and to control microorganisms growth and accumulations such as; algae, bacteria and fungi.

After traversing through media housing system 550 and before exiting the catch basin reservoir 22 through the piping exit 48, the effluent 16 will undergo one final treatment process of the ultra-filtration system 450 where it's exposed to ultra-violet, (UV) light 44 to eliminate any bacteria or viruses which may have escaped the previous filtration processes.

In understanding that the catch basin reservoir 22 was designed to operate as a standalone system it can also be equipped to operate downstream of other optional equipment such as an ultra or reverse osmosis systems or a combination of both as described above in FIG. 2.

### Exemplary Embodiment

A 3^{rd} water certification lab was hired to conduct the required series of lab tests to judge the efficiencies of the catch basin system and whether it could pass the effluent criteria for subsurface irrigation as set forth by EPA:

| Subsurface Influent Challenge | | | Treatment Results | | Pass/Fail |
|---|---|---|---|---|---|
| TSS | 30 | mg/l | Non-Detect | | X |
| Turbidity | 2 | NTU | .603 | NTU | X |
| BOD | 30 | mg/l | 16 | mg/l | X |
| COD | 90 | mg/l | 15/mg/l | | X |
| TOC | 10 | mg/l | 8 | mg/l | X |
| Total Coliforms | 200 | cfu | 100 ml 9 | cfu/100 ml | X |
| Fecal Coliforms | 200 | cfu/ml | 7 | cfu/ml | X |
| Helminth Eggs | 10/l | | Non-Detect | | X |
| Virus | 100/l | | 1/l | | X |
| Heavy Metals | .01/mg/l | | .0025 | mg/l | X |
| Inorganics | 450 | mg/l | 5.3 | mg/l | X |
| Chlorine Residual | .5 | mg/l | Non-Detect | | X |
| Nitrogen | 30 | mg/l | 5.3 | mg/l | X |
| Phosphorus | 20 | mg/l | 2.4 | mg/l | X |

For those skilled in the art, any number of media housings or media types can be utilized during the filtration process to achieve a desired degree of contamination reduction or removal for environmental release. Therefore, the present invention flow progression, media types, media housings or pre-filters utilized should not be limited to a specific type or number. While the systems, methods, and devices have been described in some detail here by way of illustration and example, such illustration and example is for purposes of clarity of understanding only. It will be readily apparent to those of ordinary skill in the art in light of the teachings herein that certain changes and modifications may be made thereto without departing from the spirit and scope of the appended claims.

What is claimed is:

1. A greywater recycling system for receiving, storing and recycling household waste influent, comprising:
(a) A pre-filtration system comprising an open-ended transversal manifold placed in an elevated position, a series of micron-sized filters for collecting the influent,
(b) a reservoir's storage system comprising: (i) a water level sensor for detecting the accumulated influent water level in a predetermined height, (ii) a pump, wherein the pump and the water level sensor are electrically connected together to automatically detect water level and activate or deactivate the pump,
(c) a media housing filtration system comprising a series of filtration media for filtering out the effluent odor and contaminants,
(d) an ultra-filtration system comprising multiple sub-micron sized filters, and
(e) a check valve for adjusting effluent water pressure and directing the effluent flow direction.

2. The greywater recycling system of claim 1, wherein the open-ended transversal manifold further comprises:
(a) a first horizontal plane portal for receiving the incoming influent,
(b) a descending curvature connected to the first horizontal plane portal lowered in a relative horizontal height compared to the first horizontal plane portal for allowing the influent from the first horizontal plane portal to migrate under gravity,
(c) a second horizontal plane portal connected to the descending curvature containing multiple descending exits coupled with multiple micro-sized filters,
(d) an ascending curvature connected to the second horizontal plane portal raised in a relative height compared to the second horizontal plane portal for redirecting the overflowed influent back to the second horizontal plane portal,
(e) a third horizontal plane portal connected to the ascending curvature for allowing the influent to exit, and
(f) a one-way backflow valve attached to the third horizontal plane portal for allowing the influent flow out to the sewer system in a one-way direction.

3. The greywater recycling system of claim 2 comprises a catch basin reservoir which stores the accumulated effluent from the system, and houses the pre-filtration system, the pump and the sensor.

4. The greywater recycling system of claim 3, wherein the catch basin reservoir comprises a plurality of housings containing multiple tapering protruding blocks and multiple tapering receiving slots matched with the tapering protruding blocks.

5. The greywater recycling system of claim 3, further comprises a tapered bay housing for storing the reservoir storage system and the electrical components of the recycling system.

6. The greywater recycling system of claim 5, wherein the water level sensor can detect the influent level to reach to a predetermined height and then activate the pump to transport the influent into the catch basin reservoir and then filter through a series of filtration media.

7. The greywater recycling system of claim 6, wherein the water level sensor can detect the influent level to a predetermined low height level and then deactivate the pump and shut off the electricity.

8. The greywater recycling system of claim 7, wherein the media housing comprises cretaceous sandstone.

9. The greywater recycling system of claim 7, wherein the media housing comprises manganese sandstone.

10. The greywater recycling system of claim 7, wherein the media housing comprises activated carbon.

11. The greywater recycling system of claim 7, wherein the media housing comprises kinetic degradation fluxion.

12. The greywater recycling system of claim 7, wherein the ultra-filtration system comprises the ionic resin beads.

13. The greywater recycling system of claim 7, wherein the ultra-filtration system comprises a reverse-osmosis system.

14. The greywater recycling system of claim 7, wherein the ultra-filtration system comprises an UV light system.

15. The greywater recycling system of claim 7, wherein the ultra-filtration system comprises a capacitive deionization (CDI).

16. The greywater recycling system of claim 7, wherein the ultra-filtration system comprises an elector-dialysis (ED).

17. The greywater recycling system of claim 7, wherein the ultra-filtration system comprises a distillation system.

18. The greywater recycling system of claim 7, wherein each of the plurality of exit openings of the manifold comprises a resistance spring for directing the influent flow and exiting the influent from the pre-filtration system out to the outside piping.

19. The greywater recycling system of claim 7, wherein the catch basin reservoir comprises a removal lid.

20. The greywater recycling system of claim 19, wherein the catch basin reservoir comprises an elevating ring spacer for elevating the height of the lid.

21. The greywater recycling system of claim 7, wherein the tapered bay housing comprises a removal lid.

22. The greywater recycling system of claim 21, wherein the tapered bay housing comprises an elevating ring spacer for elevating the height of the lid.

23. The greywater recycling system of claim 7, wherein the one-way backflow valve is a pressure-operated valve.

24. The greywater recycling system of claim 7, wherein there are multiple third plane horizontal plane portals connecting to multiple ascending curvatures.

25. The greywater recycling system of claim 7, wherein there are multiple second horizontal plane portals connected with multiple descending curvatures.

26. A method of greywater recycling system for receiving, storing and recycling household waste influent, comprising:
(a) receiving the influent through an open-ended transversal manifold having a first horizontal plane portal, a descending curvature, a second horizontal plane portal, an ascending curvature, and a third horizontal plane portal,
(b) filtering the influent through a series of micron-sized filters,
(c) detecting the influent water level in a predetermined height and electrically activating or deactivating the pump,
(d) filtering and sanitizing the outcome effluent through a series of sub-micron sized filters, and
(e) detecting the effluent water pressure and directing the effluent flow direction.

27. The method of greywater recycling system of claim 26, comprises a step of adjusting the effluent water pressure and directing the effluent flow direction.

28. The method of greywater recycling system of claim 27, wherein step (e) comprises a one-way backflow valve attached to the third horizontal plane for allowing the influent flow out to the sewer system in a one-way direction.

29. The method of greywater recycling system of claim 28, wherein step (a) comprises a pre-filtration system comprising an open-ended transversal manifold placed in an elevated position, a series of micron-sized filters for collecting the influent.

30. The method of greywater recycling system of claim 29 wherein step (b) comprises a reservoir's storage system comprising: (i) a water level sensor for detecting the accumulated influent water level in a predetermined height, (ii) a pump, wherein the pump and the water level sensor are electrically connected together to automatically detect water level and activate or deactivate the pump.

31. The method of greywater recycling system of claim 30, wherein step (c) comprises a media housing filtration system comprising a series of filtration media for filtering out the effluent odor and contaminants.

32. The method of greywater recycling system of claim 31, wherein step (d) comprises an ultra-filtration system comprising the sub-micron sized filter, the ionic resin beads, a reverse-osmosis system, and an UV light system for sanitizing and purifying the outcome effluent.

33. The method of greywater recycling system of claim 32, wherein step (d) comprises an ultra-filtration system comprising the sub-micro sized filter, the ionic resin beads, the elector-dialysis system, and an UV light system.

34. The method of greywater recycling system of claim 33, wherein step (d) comprises an ultra-filtration system comprising the sub-micro sized filter, the ionic resin beads, the elector-dialysis system, and an UV light system.

35. The method of greywater recycling system of claim 34, wherein step (d) comprises an ultra-filtration system comprising the sub-micro sized filter, the ionic resin beads, the distillation system, and an UV light system.
